(19) United States
(12) Patent Application Publication
(10) Pub. No.: US 2026/0097978 A1
(43) Pub. Date: Apr. 9, 2026

(54) SYSTEMS AND METHODS FOR DELIVERING ACID DIRECTLY TO A POOL

(71) Applicant: SIDNEY GLUCKMAN, NEWBERRY, FL (US)

(72) Inventor: SIDNEY GLUCKMAN, NEWBERRY, FL (US)

(21) Appl. No.: 18/909,185

(22) Filed: Oct. 8, 2024

(51) Int. Cl. C02F 1/68; C02F 1/00; C02F 1/66; C02F 103/42

(52) U.S. Cl. CPC C02F 1/686; C02F 1/008; C02F 1/66; C02F 2103/42; C02F 2201/008; C02F 2201/009; C02F 2209/006; C02F 2209/06; C02F 2209/38; C02F 2303/08

(57) ABSTRACT

Systems, devices, and methods are provided for delivering acid (or other liquids) directly to a pool while floating within the pool. A floating device can include the liquid to be delivered to the pool stored in an on-board tank that also serves as a flotation device, utilizing the remaining air in the tank to create buoyancy. The liquid can alternatively be provided in a separate container that is disposed in or on the floating device. Because the floating device is small and non-permanent, it can be easily removed from the pool at any time, such as for aesthetic purposes.

### BACKGROUND

Modern salt pool chlorine generation raises pH levels due to the fact that the electrolysis process that generates chlorine also creates byproducts that have high pH levels. Sodium hydroxide, for example, can have a pH of over 13, and this can constantly increase the pH levels of the water in the pool. The chlorine gas that results from the process is also basic and raises the pH when dissolved as well.

Pool water with a pH that is too high can cause several issues. When the water is too alkaline, the chlorine loses its effectiveness in killing pathogens in the pool. Water that is too alkaline can also cause skin rashes, cloudy water, and scaling on pool surfaces and equipment.

Hence, acid solution is frequently added to the pool to lower the pH. Depending on the size of the pool, this can be a daily requirement. The pH must also be carefully monitored to prevent or inhibit the addition of too much acid, causing a pH crash. If left untreated, this situation can quickly corrode pool equipment. The commonly used approach is frequent, small doses of acid to precisely control the pH. This can be inconvenient for the average pool owner doing his or her own pool maintenance.

### BRIEF SUMMARY

In order to address the issues discussed in the Background section, embodiments of the subject invention provide novel and advantageous systems, devices, and methods for delivering acid (or other liquids) directly to a pool while floating within the pool. A floating device can include the acid (or other liquid) to be delivered to the pool stored in an on-board tank that also serves as a flotation device, utilizing the remaining air in the tank to create buoyancy. The acid (or other liquid) can alternatively be provided in a separate container (e.g., a jug, such as an off-the-shelf jug) that is disposed in or on the floating device. Because the floating device is much smaller than related art devices while also being non-permanent (i.e., configured to be mobile and movable), it can be easily removed from the pool at any time (e.g., for aesthetic purposes).

In an embodiment, a device for delivering a liquid directly to a pool can comprise: a tank configured to hold the liquid; a control box disposed on the tank; and a pH sensing probe. The control box can comprise: a main body; a removable cover disposed on the main body; a solar cell disposed on the removable cover; a relief valve disposed in the main body; an air pump disposed in the main body; a control board disposed in the main body; a pH sensing circuitry disposed on the control board, the pH sensing circuitry being connected to the pH sensing probe and configured to receive signals from the pH sensing probe; a battery disposed on the control board; a solar charge controller disposed on the control board; a pump relay disposed on the control board; and a main controller disposed on the control board and configured to control the pH sensing circuitry, the pump relay, and the relief valve. The device can further comprise: an air pump tube chase connected to the air pump and open to an inside of the tank via an air pump hole on an upper surface of the tank; and a relief valve tube connected to the relief valve and open to the inside of the tank via a relief hole on the upper surface of the tank. The tank can comprise a liquid exit comprising an exit hole on a side surface of the tank. The device can be configured such that, when air is pumped into the inside of the tank by the air pump, the liquid is delivered to the pool via the liquid exit. The device can be configured such that, when air is not being pumped into the inside of the tank, the inside of the tank is vented via the relief valve and liquid is not forced out of the tank via the liquid exit. The device can be configured to float in the pool during use. The device can have a total volume of, for example, no more than 3 cubic feet (ft³). The control box can comprise at least one vent on a side surface thereof. The tank can further comprise: a probe hole through which the pH sensing probe is disposed without being exposed to the inside of the tank; and/or a fill hole on the upper surface thereof configured to receive the liquid. The tank can be configured such that the fill hole is sealed airtight during use of the device and open during replenishment of the liquid to the tank. The liquid exit can further comprise a partial wall disposed proximate to the exit hole, the partial wall having a bottom surface that is farther from the upper surface of the tank than is the exit hole. The control box can further comprise at least one fastener configured to removably attach the removable cover to the main body of the control box. The control box can comprise a first hole through which the pH sensing probe passes, a second hole through which the air pump tube chase passes, and/or a third hole through which the relief valve tube passes. The device can further comprise a software module in operable communication with the main controller, and the software module can be configured such that a user of the device inputs parameters of the device via the software module. The parameters can comprise a setpoint of a pH level of the pool. The liquid can be acid, and the device can be configured such that it does not corrode from the acid (e.g., based on the materials of the components of the device).

In another embodiment, a device for delivering a liquid directly to a pool can comprise: a housing configured to hold a removable container of the liquid; a control box disposed on the housing; and a pH sensing probe. The control box can comprise: a main body; a removable cover disposed on the main body; a solar cell disposed on the removable cover; a relief valve disposed in the main body; an air pump disposed in the main body; a control board disposed in the main body; a pH sensing circuitry disposed on the control board, the pH sensing circuitry being connected to the pH sensing probe and configured to receive signals from the pH sensing probe; a battery disposed on the control board; a solar charge controller disposed on the control board; a pump relay disposed on the control board; and a main controller disposed on the control board and configured to control the pH sensing circuitry, the pump relay, and the relief valve. The device can further comprise: a joined air tube connected to both the air pump and the relief valve tube, the joined air tube being configured to be open to an inside of the removable container; and a liquid discharge tube configured to have a first end thereof disposed in the removable container and a second end thereof opposite from the first end disposed in the pool during use. The device can be configured such that, when air is pumped into the inside of the removable container by the air pump, the liquid is delivered to the pool via the liquid discharge tube. The device can be configured such that, when air is not being pumped into the inside of the removable container, the inside of the removable container is vented via the relief valve and liquid is not forced out of the removable container via the liquid discharge tube. The device can be configured to float in the pool during use. The device can have a total volume of, for example, no more than 3 ft³. The control box can comprise at least one vent on a side surface thereof. The housing can comprise a probe hole through which the pH sensing probe is disposed. The device can further comprise a specialized cap configured to fit on the removable container. The specialized cap can comprise a first hole through which the joined air tube is disposed with an airtight seal during use and a second hole through which the liquid discharge tube is disposed with an airtight seal during use. The housing can comprise: a main housing comprising a container hole configured to receive the removable container; a collar disposed around the main housing; and a container housing disposed below the main housing and configured to hold the removable container. The control box can further comprise at least one fastener configured to removably attach the removable cover to the main body of the control box. The control box can further comprise a third hole through which the pH sensing probe passes and a fourth hole through which the joined air tube passes. The device can further comprise a software module in operable communication with the main controller. The software module can be configured such that a user of the device inputs parameters of the device via the software module. The parameters can comprise a setpoint of a pH level of the pool. The liquid can be acid, and the device can be configured such that it does not corrode from the acid (e.g., based on the materials of the components of the device).

In another embodiment, a method for delivering acid directly to a pool can comprise: providing a device as disclosed herein (e.g., having any or all of the features from the previous paragraph or the paragraph previous to that), such that the device is floating in the pool; and operating the device to provide regular doses of the acid to the pool while the device is floating within the pool.

### BRIEF DESCRIPTION OF DRAWINGS

FIG. 1 shows a schematic view of a system for delivering acid (or other liquid) to a pool, according to an embodiment of the subject invention.

FIG. 2 shows a cross-sectional view of a system for delivering acid (or other liquid) to a pool, according to an embodiment of the subject invention.

FIG. 3 shows a top view of a system for delivering acid (or other liquid) to a pool, according to an embodiment of the subject invention.

FIG. 4 shows a schematic view of a system for delivering acid (or other liquid) to a pool, according to an embodiment of the subject invention.

FIG. 5 shows a cross-sectional view of a system for delivering acid (or other liquid) to a pool, according to an embodiment of the subject invention.

FIG. 6 shows a top view of a system for delivering acid (or other liquid) to a pool, according to an embodiment of the subject invention.

### DETAILED DESCRIPTION

Embodiments of the subject invention provide novel and advantageous systems, devices, and methods for delivering acid (or other liquids) directly to a pool while floating within the pool. A floating device can include the acid (or other liquid) to be delivered to the pool stored in an on-board tank that also serves as a flotation device, utilizing the remaining air in the tank to create buoyancy. The acid (or other liquid) can alternatively be provided in a separate container (e.g., a jug, such as an off-the-shelf jug) that is disposed in or on the floating device. Because the floating device is much smaller than related art devices while also being non-permanent (i.e., configured to be mobile and movable), it can be easily removed from the pool at any time (e.g., for aesthetic purposes).

Related art systems from major pool equipment manufacturers are large acid dispensing systems (e.g., volume of greater than 6 cubic feet (ft³) and in many cases much larger) that require permanent installation (e.g., affixed to the floor, ground, or wall) and utilize components (e.g., the acid delivery mechanism) that need regular maintenance to prevent issues. Such acid delivery systems utilize a peristaltic pump to dispense the acid. These pumps, while accurate, require the acid to move through flexible tubing, which does not stand up to the acid indefinitely, so it must be regularly replaced (e.g., every 1-4 months). If this maintenance is not done, then the acid leaks out of the tubes and can quickly cause damage to other components.

Embodiments of the subject invention can be small (e.g., volume of 3 ft³ or less) and non-permanent (i.e., configured to be mobile and movable, such as by a single person picking it up out of the pool). Embodiments can also advantageously utilize an air displacement mechanism to deliver acid to the pool, whereby a small pump delivers air into the tank or container (e.g., at precise intervals), creating a pressure that forces the liquid (e.g., acid) out of the tank or removable container (e.g., jug). The liquid (e.g., acid) can be delivered from the tank or container to the pool via, for example, a delivery tube or hole in the tank that opens to the pool, or via a delivery tube disposed in the container and disposed in or over the pool. The delivery tube or hole in the tank can be integrated into the structure of the tank (e.g., monolithically formed with the tank) or the delivery tube can be attached to the tank.

Over-pressurization in the tank could result in the acid continuing to flow after the pump stops. In order to solve this, an air valve (e.g., a two-way, normally open air valve) can be included in the system. When no pumping is occurring, the air valve (which can be referred to as a relief valve) can be deactivated and open to the atmosphere. This can effectively vent the tank to atmosphere to allow normal thermal expansion of the air inside the tank. When the pump is activated, the relief valve can be simultaneously closed to allow pressure to build and the acid to be dispensed. When the acid dose is complete, the pump can stop and the relief valve can be simultaneously deactivated to allow the residual pressure in the tank to completely dissipate, thereby immediately stopping the flow of acid out of the tank.

The system can also include a pH probe and supporting sensing circuitry to accurately monitor the pH of the pool. This can be used to determine the amount of acid (or dose) that needs to be dispensed at any given time. A controller (e.g., a micro-controller) and software module can be configured and used to control the dosing process. Using a closed-loop control technique, the software module can accurately learn the response of the pool pH to a given dose, and consistently deliver a time-adjusted dose to precisely maintain the desired pH (which can be set by a user of the system).

The system can also include a solar cell, battery, and/or charging circuit to allow the floating device to operate on its own indefinitely, without the need for wires or external power. The only ongoing maintenance necessary is to refill the liquid (e.g., acid) when needed (e.g., every 1-5 weeks).

In some embodiments, a peristaltic pump can be used for the acid delivery, but this is less preferred than the air displacement mechanism because the use of a peristaltic pump also has the same drawbacks (e.g., maintenance requirements) discussed herein for related art systems.

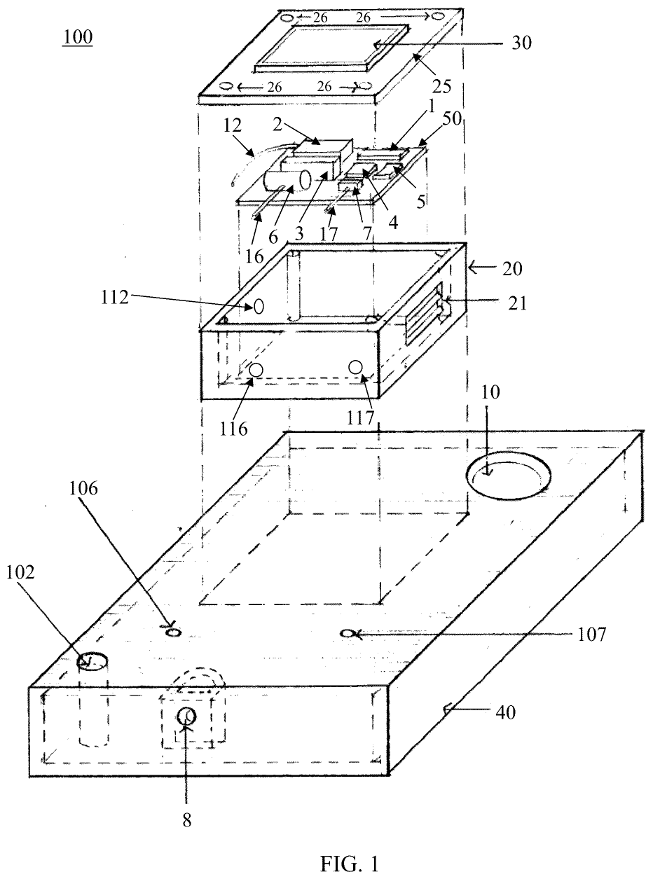

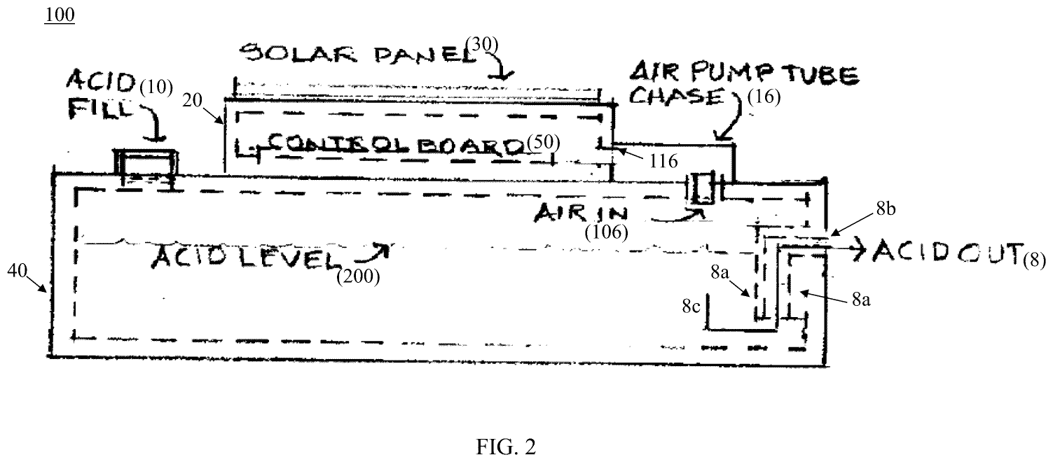

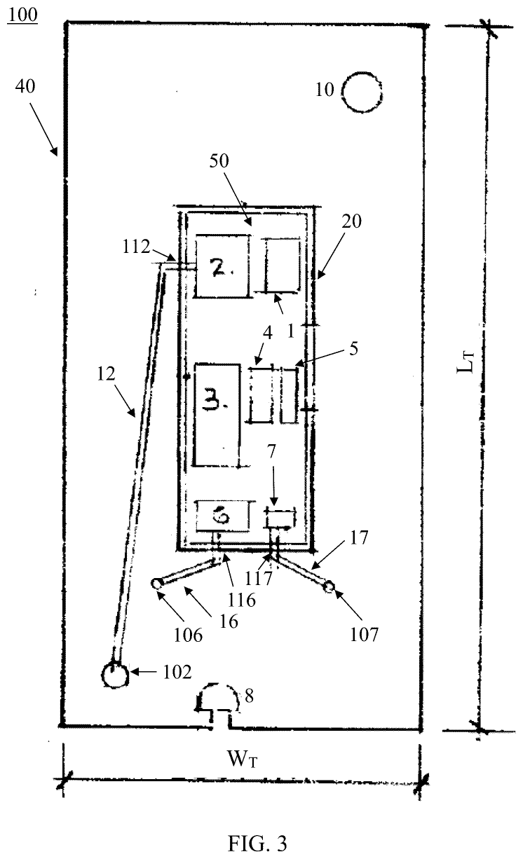

FIG. 1 shows a schematic view of a system for delivering acid (or other liquid) to a pool, according to an embodiment of the subject invention. FIG. 2 shows a cross-sectional view of the system from FIG. 1, and FIG. 3 shows a top view of the system from FIGS. 1 and 2. Referring to FIGS. 1-3, the system can include a floating device 100 comprising a tank 40 and a control box 20. The control box 20 can include a control board 50 disposed therein, and the control board 50 can have disposed thereon a main controller 1, pH sensing circuitry 2, a battery 3, a solar charge controller 4, a pump relay 5, and an air pump 6. The pH sensing circuitry 2 can be connected to a pH sensing probe 12 configured to be disposed in the water of the pool, such as through an optional hole 102 that goes through the tank 40 without being open to the inside of the tank 40. The hole 102 can help keep the pH sensing probe 12 in place and inhibit it from popping up out of the water during use. The pH sensing probe 12 can exit the control box 20 via a hole 112 in the control box 20. The battery 3 and/or the solar charge controller 4 can be in operable communication with a solar panel 30, which can be disposed, e.g., on a cover 25 of the control box 20.

The air pump 6 can be in operable communication with the pump relay 5 and can be connected to an air pump tube chase 16 that is open to the inside of the tank 40 via an air pump hole 106 on an upper surface of the tank 40. The system can include a relief valve 7, which can be disposed in the control box 20 (e.g., on the control board 50). The relief valve 7 can be connected to a relief valve tube 17 that is open to the inside of the tank 40 via a relief hole 107 on the upper surface of the tank 40. The air pump tube chase 16 and the relief valve tube 17 can exit the control box 20 via respective holes 116,117 in the control box 20.

The control box 20 can include at least one vent 21 to help cool the components disposed therewithin. The control box 20 can have a removable cover 25 for case of checking and/or maintaining the components disposed therein. The cover 25 can be attached to the remainder of the control box 20 via at least one fastener 26 (e.g., screw), such as four fasteners disposed at the corners of the cover 25.

The tank 40 can have a fill hole 10 disposed on the upper surface thereof such that the liquid (e.g., acid) can be added to the tank 40. The fill hole 10 can be configured to be scaled (e.g., via a screw cap or similar). The tank 40 can include a liquid (e.g., acid) exit 8 on a side surface thereof, and the liquid exit 8 can include, for example, a partial wall 8a that extends below a hole 8b on the side surface of the tank 40 (i.e., the bottom of the partial wall 8a is farther from the upper surface of the tank 40 than is the hole 8b). In exiting the tank 40 via the liquid exit 8, the liquid can take a path 8c below the bottom of the partial wall 8a, up to the hole 8b, and then out through the hole 8b into the pool. FIG. 2 shows an example of the level 200 of the liquid within the tank 40, and the level 200 would need to be higher than the bottom of the partial wall 8a in order for the liquid to be able to be discharged from the tank 40 via the liquid exit 8 (i.e., follow the path 8c through the hole 8b out of the tank 40). If the level 200 falls below the bottom of the partial wall 8a, the user will need to refill the tank 40 (e.g., using the fill hole 10).

During use, the air pump 6 provides air to the tank 40 via the air pump tube chase 16, which increases the pressure in the tank 40 and causes the liquid (e.g., acid) to discharge from the tank 40 to the pool via the liquid exit 8. When no pumping is occurring, the relief valve 7 can be open to the atmosphere, effectively venting the tank 40 to atmosphere via the relief valve tube 17 and the relief valve 7 to allow normal thermal expansion of the air inside the tank 40. When the air pump 6 is activated, the relief valve 7 can be closed (e.g., simultaneously closed) to allow pressure to build and the liquid to be discharged from the tank 40. When the dose is complete, the air pump 6 can stop and the relief valve 7 can be deactivated (e.g., simultaneously deactivated) to allow the residual pressure in the tank 40 to completely dissipate, thereby immediately stopping the flow of liquid out of the tank 40.

The main controller 1 can include at least one processor and can communicate with the software module discussed herein. The software module can be stored locally, such as on memory disposed on or in the main controller 1 and/or on the control board 50. Alternatively, the software module can be stored remotely, and the main controller 1 can communicate with the software module wirelessly (e.g., via WiFi and/or Bluetooth). In either case, the system can include a user interface (which may be web-based, cloud-based, and/or locally stored on a device of the user) for using the software module to set the desired pH, manually alter the dose of liquid to be provided to the pool, set designated on/off times for the floating device 100, etc.

It is noted that FIG. 3 shows a top view of the floating device 100 with the cover 25 of the control box 20 removed such that the components disposed within the control box 20 can be seen. The tank 40 (and therefore the entire floating device 100) can have a width WT in a range of, for example, from 100 millimeters (mm) to 800 mm (or any value, about any value, or any subrange therewithin). For example, the tank 40 can have a width WT of 200 mm or about 200 mm. The tank 40 (and therefore the entire floating device 100) can have a length LT in a range of, for example, from 100 mm to 1,200 mm (or any value, about any value, or any subrange therewithin). For example, the tank 40 can have a length LT of 400 mm or about 400 mm. The floating device 100 can have a height (measured in a direction perpendicular to the directions in which the width WT and the length LT are measured) in a range of, for example, from 100 mm to 1,000 mm (or any value, about any value, or any subrange therewithin).

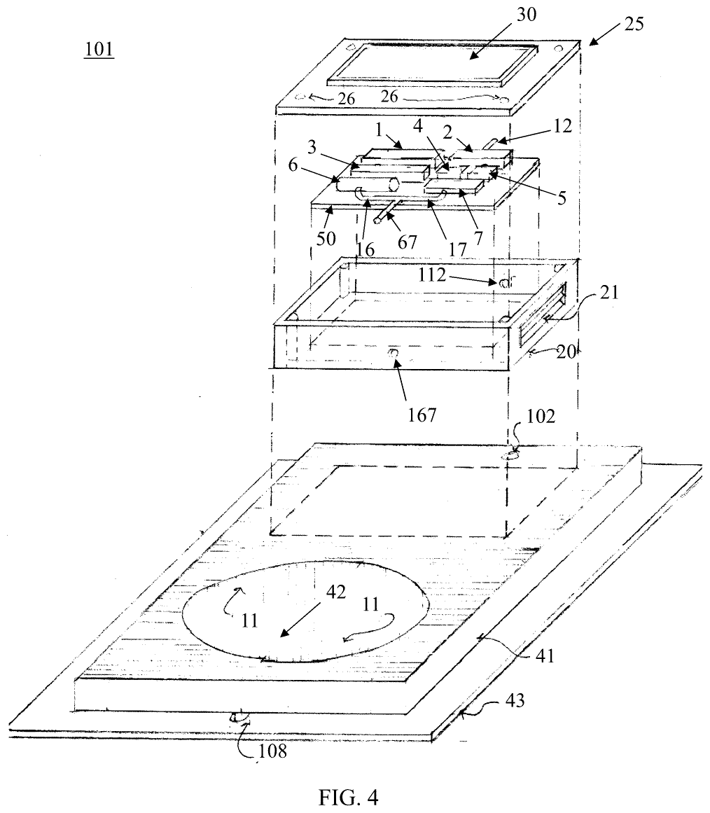

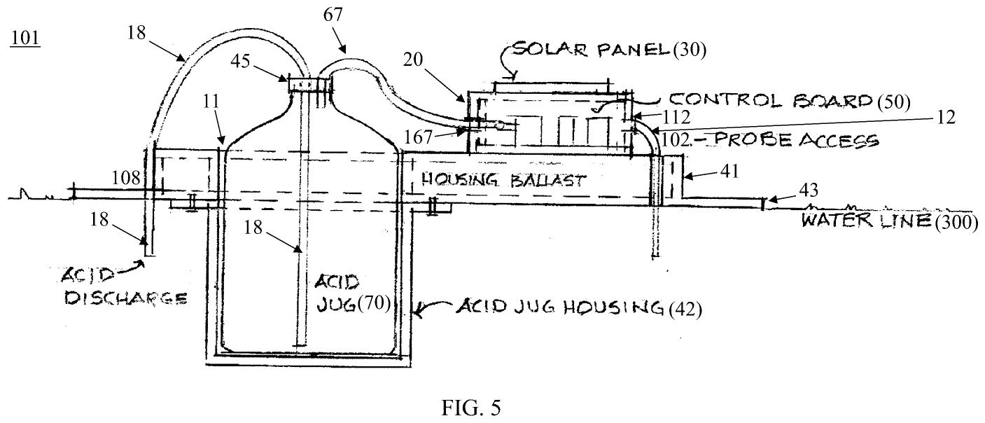

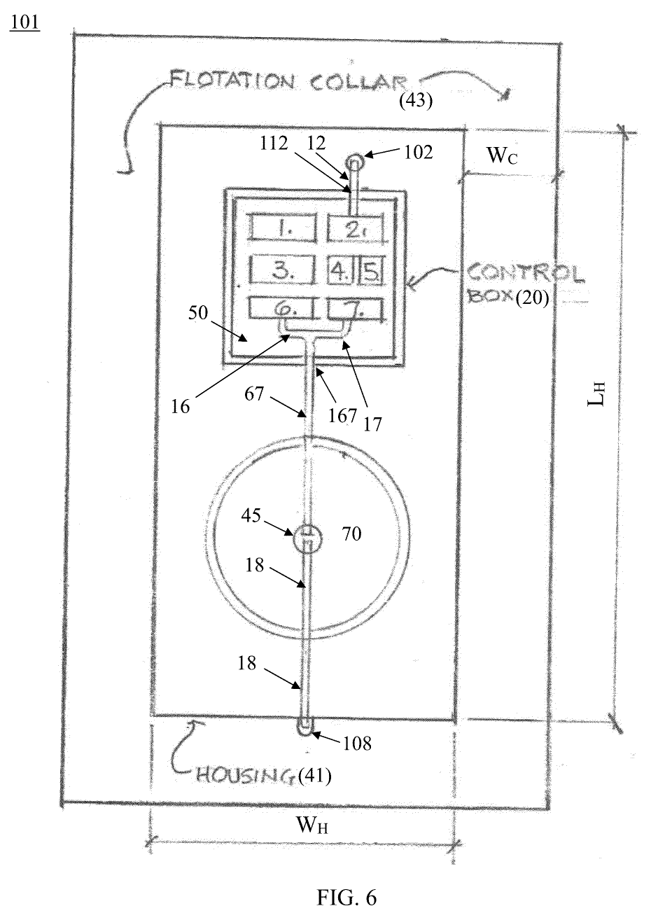

FIG. 4 shows a schematic view of a system for delivering acid (or other liquid) to a pool, according to an embodiment of the subject invention. FIG. 5 shows a cross-sectional view of the system from FIG. 4, and FIG. 6 shows a top view of the system from FIGS. 4 and 5. Referring to FIGS. 4-6, in this embodiment the system includes a floating device 101 comprising a control box 20 and a housing 41,42,43 designed to hold a removable container 70 (e.g., a jug) of the liquid (e.g., acid). The housing 101 can comprise a collar 43 disposed around and/or under a main housing 41; the collar 43, which can be made of a material configured to help the floating device 101 float, can be attached (e.g., irremovably attached or removably attached) to the main housing 41. The housing 41,42,43 can include the main housing 41 (which may be referred to as housing ballast) and a container housing 42. The container housing 42 can be monolithically formed with the main housing 41 or can be attached (e.g., irremovably attached or removably attached) to the main housing 41. The collar 43 can be monolithically formed with the main housing 41 or can be attached (e.g., irremovably attached or removably attached) to the main housing 41. The main housing 41, the container housing 42, and/or the collar 43 can be configured (e.g., based on material and size) to help the floating device 101 float in the pool. The main housing 41 can include a hole 11 in an upper surface thereof to accommodate the container 70.

The control box 20 can include a control board 50 disposed therein, and the control board 50 can have disposed thereon a main controller 1, pH sensing circuitry 2, a battery 3, a solar charge controller 4, a pump relay 5, and an air pump 6. The pH sensing circuitry 2 can be connected to a pH sensing probe 12 configured to be disposed in the water of the pool, such as through an optional hole 102 that goes through the main housing 41. The hole 102 can help keep the pH sensing probe 12 in place and inhibit it from popping up out of the water during use. The pH sensing probe 12 can exit the control box 20 via a hole 112 in the control box 20. The battery 3 and/or the solar charge controller 4 can be in operable communication with a solar panel 30, which can be disposed, e.g., on a cover 25 of the control box 20.

The air pump 6 can be in operable communication with the pump relay 5 and can be connected to an air pump tube 16. The system can include a relief valve 7, which can be disposed in the control box 20 (e.g., on the control board 50). The relief valve 7 can be connected to a relief valve tube 17, and the air pump tube 16 and the relief valve tube 17 can join together to form a joined air tube 67 that can be open to the inside of the container 70. The joined air tube 67 can exit the control box 20 via a hole 167 in the control box 20.

The control box 20 can include at least one vent 21 to help cool the components disposed therewithin. The control box 20 can have a removable cover 25 for ease of checking and/or maintaining the components disposed therein. The cover 25 can be attached to the remainder of the control box 20 via at least one fastener 26 (e.g., screw), such as four fasteners disposed at the corners of the cover 25.

The system can include a liquid discharge tube 18 disposed in the container 70 and configured to extend to a lower portion of the liquid (e.g., acid) contained in the container 70. The liquid discharge tube extends into the pool during use, such that the liquid (e.g., acid) can be discharged from the container 70 into the pool via the liquid discharge tube 18. The liquid discharge tube 18 can pass through an optional hole 108 in the collar 43 or the main housing 41. The hole 108 can help keep the liquid discharge tube 18 in place and inhibit it from popping up out of the water during use.

The system can include a specialized cap 45 for the container 70, and the cap 45 can have two holes in it designed for the joined air tube 67 and the liquid discharge tube 18 to pass therethrough, respectively. The specialized cap 45 can have the joined air tube 67 and the liquid discharge tube 18 disposed therethrough such that they are not able to be easily removed. That is, when a new container 70 is provided to the floating device 101, the specialized cap 45 having the joined air tube 67 and the liquid discharge tube 18 already disposed therethrough is screwed on the container 70. Alternatively, the specialized cap 45 can be designed such that the joined air tube 67 and the liquid discharge tube 18 are easily removed through the holes in the specialized cap 45. In this case, when a new container 70 is provided to the floating device 101, the joined air tube 67 and the liquid discharge tube 18 are disposed through the respective holes in the specialized cap 45 (either before screwing it on the container 70 or after). As another alternative, the existing cap of the container 70 can be used, and holes for the joined air tube 67 and the liquid discharge tube 18 can be made in the existing cap. The holes in the cap (whether the container's original cap or the specialized cap 45) should be airtight, such that the cap forms an airtight seal when in place and allows the pumped-in air to push out the liquid during use.

During use, the air pump 6 provides air to the container 70 via the air pump tube 16 and the joined air tube 67, which increases the pressure in the container 70 and causes the liquid (e.g., acid) to discharge from the container 70 to the pool via the liquid discharge tube 18. When no pumping is occurring, the relief valve 7 can be open to the atmosphere, effectively venting the container 70 to atmosphere via the joined air tube 67, the relief valve tube 17, and the relief valve 7 to allow normal thermal expansion of the air inside the container 70. When the air pump 6 is activated, the relief valve 7 can be closed (e.g., simultaneously closed) to allow pressure to build and the liquid to be discharged from the container 70. When the dose is complete, the air pump 6 can stop and the relief valve 7 can be deactivated (e.g., simultaneously deactivated) to allow the residual pressure in the container 70 to completely dissipate, thereby immediately stopping the flow of liquid out of the container 70.

The main controller 1 can include at least one processor and can communicate with the software module discussed herein. The software module can be stored locally, such as on memory disposed on or in the main controller 1 and/or on the control board 50. Alternatively, the software module can be stored remotely, and the main controller 1 can communicate with the software module wirelessly (e.g., via WiFi and/or Bluetooth). In either case, the system can include a user interface (which may be web-based, cloud-based, and/or locally stored on a device of the user) for using the software module to set the desired pH, manually alter the dose of liquid to be provided to the pool, set designated on/off times for the floating device 101, etc.

It is noted that FIG. 3 shows a top view of the floating device 101 with the cover 25 of the control box 20 removed such that the components disposed within the control box 20 can be seen. The main housing 41 can have a width WH in a range of, for example, from 100 mm to 800 mm (or any value, about any value, or any subrange therewithin). For example, the main housing 41 can have a width WH of 200 mm or about 200 mm. The main housing 41 can have a length LH in a range of, for example, from 100 mm to 1,200 mm (or any value, about any value, or any subrange therewithin). For example, the main housing 41 can have a length LH of 400 mm or about 400 mm. The collar 43 can have a width Wc in a range of, for example, from 20 mm to 300 mm (or any value, about any value, or any subrange therewithin). For example, the collar 43 can have a width Wc of 60 mm or about 60 mm. The length of the collar 43 (measured in the same direction as LH) can also be in a range of, for example, from 20 mm to 300 mm (or any value, about any value, or any subrange therewithin; for example, about 60 mm).

The floating device 101 can have a width (measured in the same direction as WH) in a range of, for example, from 200 mm to 900 mm (or any value, about any value, or any subrange therewithin, e.g., 320 mm or about 320 mm). The floating device 101 can have a length (measured in the same direction as LH) in a range of, for example, from 300 mm to 1,000 mm (or any value, about any value, or any subrange therewithin, e.g., 520 mm or about 520 mm). The floating device 101 can have a height (measured in a direction perpendicular to the directions in which the width WHI and the length LH are measured) in a range of, for example, from 100 mm to 1,000 mm (or any value, about any value, or any subrange therewithin).

In some embodiments, the floating device 100,101 can include an air check-valve (not pictured) inline with the pump 6 configured to inhibit or prevent fluid (e.g., vapors, such as acid vapors) from back-flowing into the pump 6 during use. The air check-valve can be disposed on, for example, the air pump tube chase 16, air pump tube 16, or joined air tube 67.

In an embodiment, a method for delivering acid (or other liquid) directly to a pool can comprise: providing a floating device 100 or 101 as described herein, and operating the floating device to provide regular doses of acid (or other liquid) to the pool while the floating device is floating within the pool. The user interface for the software module can be used to set parameters for the floating device.

Although acid is discussed herein as the liquid delivered to a pool, embodiments of the subject invention can also be used to deliver other liquids (e.g., a basic solution) to a pool. The software module (e.g., via the user interface) can be used to set desired parameters, and the system would operate the same as discussed for acid delivery.

The methods and processes described herein can be embodied as code and/or data. The software code and data described herein can be stored on one or more machine-readable media (e.g., computer-readable media), which may include any device or medium that can store code and/or data for use by a computer system. When a computer system and/or processor reads and executes the code and/or data stored on a computer-readable medium, the computer system and/or processor performs the methods and processes embodied as data structures and code stored within the computer-readable storage medium.

It should be appreciated by those skilled in the art that computer-readable media include removable and non-removable structures/devices that can be used for storage of information, such as computer-readable instructions, data structures, program modules, and other data used by a computing system/environment. A computer-readable medium includes, but is not limited to, volatile memory such as random access memories (RAM, DRAM, SRAM); and non-volatile memory such as flash memory, various read-only-memories (ROM, PROM, EPROM, EEPROM), magnetic and ferromagnetic/ferroelectric memories (MRAM, FeRAM), and magnetic and optical storage devices (hard drives, magnetic tape, CD, DVDs); network devices; or other media now known or later developed that are capable of storing computer-readable information/data. Computer-readable media should not be construed or interpreted to include any propagating signals. A computer-readable medium of embodiments of the subject invention can be, for example, a compact disc (CD), digital video disc (DVD), flash memory device, volatile memory, or a hard disk drive (HDD), such as an external HDD or the HDD of a computing device, though embodiments are not limited thereto. A computing device can be, for example, a laptop computer, desktop computer, server, cell phone, or tablet, though embodiments are not limited thereto.

When the term module is used herein, it can refer to software and/or one or more algorithms to perform the function of the module; alternatively, the term module can refer to a physical device configured to perform the function of the module (e.g., by having software and/or one or more algorithms stored thereon).

When ranges are used herein, combinations and subcombinations of ranges (including any value or subrange contained therein) are intended to be explicitly included. When the term “about” is used herein, in conjunction with a numerical value, it is understood that the value can be in a range of 95% of the value to 105% of the value, i.e. the value can be +/−5% of the stated value. For example, “about 1 kg” means from 0.95 kg to 1.05 kg.

It should be understood that the examples and embodiments described herein are for illustrative purposes only and that various modifications or changes in light thereof will be suggested to persons skilled in the art and are to be included within the spirit and purview of this application.

All patents, patent applications, provisional applications, and publications referred to or cited herein are incorporated by reference in their entirety, including all figures and tables, to the extent they are not inconsistent with the explicit teachings of this specification.

What is claimed is:

1. A device for delivering a liquid directly to a pool, the device comprising:
a tank configured to hold the liquid;
a control box disposed on the tank; and
a pH sensing probe;
wherein the control box comprises:
a main body;
a removable cover disposed on the main body;
a solar cell disposed on the removable cover;
a relief valve disposed in the main body;
an air pump disposed in the main body;
a control board disposed in the main body;
a pH sensing circuitry disposed on the control board, the pH sensing circuitry being connected to the pH sensing probe and configured to receive signals from the pH sensing probe;
a battery disposed on the control board;
a solar charge controller disposed on the control board;
a pump relay disposed on the control board; and
a main controller disposed on the control board and configured to control the pH sensing circuitry, the pump relay, and the relief valve,
wherein the device further comprises:
an air pump tube chase connected to the air pump and open to an inside of the tank via an air pump hole on an upper surface of the tank; and
a relief valve tube connected to the relief valve and open to the inside of the tank via a relief hole on the upper surface of the tank,
wherein the tank comprises a liquid exit comprising an exit hole on a side surface of the tank,
wherein the device is configured such that, when air is pumped into the inside of the tank by the air pump, the liquid is delivered to the pool via the liquid exit,
wherein the device is configured such that, when air is not being pumped into the inside of the tank, the inside of the tank is vented via the relief valve and liquid is not forced out of the tank via the liquid exit, and
wherein the device is configured to float in the pool during use.

2. The device according to claim 1, wherein the device has a total volume of no more than 3 cubic feet (ft³).

3. The device according to claim 1, wherein the control box further comprises at least one vent on a side surface thereof.

4. The device according to claim 1, wherein the tank further comprises a probe hole through which the pH sensing probe is disposed without being exposed to the inside of the tank.

5. The device according to claim 1, wherein the tank further comprises a fill hole on the upper surface thereof configured to receive the liquid,
wherein the tank is configured such that the fill hole is sealed airtight during use of the device and open during replenishment of the liquid to the tank.

6. The device according to claim 1, wherein the liquid exit further comprises a partial wall disposed proximate to the exit hole, the partial wall having a bottom surface that is farther from the upper surface of the tank than is the exit hole.

7. The device according to claim 1, wherein the control box further comprises a first hole through which the pH sensing probe passes, a second hole through which the air pump tube chase passes, and a third hole through which the relief valve tube passes.

8. The device according to claim 1, further comprising a software module in operable communication with the main controller,
wherein the software module is configured such that a user of the device inputs parameters of the device via the software module, the parameters comprising a setpoint of a pH level of the pool.

9. The device according to claim 1, wherein the liquid is acid, and
wherein the device is configured such that it does not corrode from the acid.

10. A method for delivering acid directly to a pool, the method comprising:
providing the device according to claim 1, such that the device is floating in the pool; and
operating the device to provide regular doses of the acid to the pool while the device is floating within the pool.

11. A device for delivering a liquid directly to a pool, the device comprising:
a housing configured to hold a removable container of the liquid;
a control box disposed on the housing; and
a pH sensing probe;
wherein the control box comprises:
a main body;
a removable cover disposed on the main body;
a solar cell disposed on the removable cover;
a relief valve disposed in the main body;
an air pump disposed in the main body;
a control board disposed in the main body;
a pH sensing circuitry disposed on the control board, the pH sensing circuitry being connected to the pH sensing probe and configured to receive signals from the pH sensing probe;
a battery disposed on the control board;
a solar charge controller disposed on the control board;
a pump relay disposed on the control board; and
a main controller disposed on the control board and configured to control the pH sensing circuitry, the pump relay, and the relief valve,
wherein the device further comprises:
a joined air tube connected to both the air pump and the relief valve tube, the joined air tube being configured to be open to an inside of the removable container; and
a liquid discharge tube configured to have a first end thereof disposed in the removable container and a second end thereof opposite from the first end disposed in the pool during use,
wherein the device is configured such that, when air is pumped into the inside of the removable container by the air pump, the liquid is delivered to the pool via the liquid discharge tube,
wherein the device is configured such that, when air is not being pumped into the inside of the removable container, the inside of the removable container is vented via the relief valve and liquid is not forced out of the removable container via the liquid discharge tube, and
wherein the device is configured to float in the pool during use.

12. The device according to claim 11, wherein the device has a total volume of no more than 3 cubic feet (ft³).

13. The device according to claim 11, wherein the control box further comprises at least one vent on a side surface thereof.

14. The device according to claim 11, wherein the housing comprises a probe hole through which the pH sensing probe is disposed.

15. The device according to claim 11, further comprising a specialized cap configured to fit on the removable container,
wherein the specialized cap comprises a first hole through which the joined air tube is disposed with an airtight seal during use and a second hole through which the liquid discharge tube is disposed with an airtight seal during use.

16. The device according to claim 11, wherein the housing comprises:
a main housing comprising a container hole configured to receive the removable container;
a collar disposed around the main housing; and
a container housing disposed below the main housing and configured to hold the removable container.

17. The device according to claim 11, wherein the control box further comprises a third hole through which the pH sensing probe passes and a fourth hole through which the joined air tube passes.

18. The device according to claim 11, further comprising a software module in operable communication with the main controller,
wherein the software module is configured such that a user of the device inputs parameters of the device via the software module, the parameters comprising a setpoint of a pH level of the pool.

19. The device according to claim 11, wherein the liquid is acid, and
wherein the device is configured such that it does not corrode from the acid.

20. A method for delivering acid directly to a pool, the method comprising:
providing the device according to claim 11, such that the device is floating in the pool; and
operating the device to provide regular doses of the acid to the pool while the device is floating within the pool.
